(19) United States
(12) Patent Application Publication
(10) Pub. No.: US 2013/0254520 A1
(43) Pub. Date: Sep. 26, 2013

(54) METHOD AND APPARATUS FOR PROVIDING DATA MIGRATION SERVICES

(71) Applicants: MARC STEVEN BIRNKRANT, POWAY, CA (US); GARY ROBERT LYONS, SAN DIEGO, CA (US); EDWARD THEODORE WINTER, SAN DIEGO, CA (US)

(72) Inventors: MARC STEVEN BIRNKRANT, POWAY, CA (US); GARY ROBERT LYONS, SAN DIEGO, CA (US); EDWARD THEODORE WINTER, SAN DIEGO, CA (US)

(73) Assignee: Sony Corporation, Tokyo (JP)

(21) Appl. No.: 13/425,225

(22) Filed: Mar. 20, 2012

(51) Int. Cl. G06F 9/00

(52) U.S. Cl. 713/2

(57) ABSTRACT

A method and apparatus for providing data migration services for a device such as a computer is disclosed. The method for data migration comprises collecting a plurality of parameters from a user device, storing the plurality of parameters as migration data in a database, and imaging a new device with the migration data.

### CROSS REFERENCE TO RELATED APPLICATIONS

Commonly assigned and related United States Patent Application Attorney Docket Number SCA2356, entitled “Method and Apparatus for Providing Data Migration Services”, filed simultaneously herewith, is hereby incorporated by reference in its entirety.

### BACKGROUND

1. Field of the Invention

Embodiments of the present invention generally relate to backup and restoration techniques for a digital device, and more specifically to a method and apparatus for providing data migration services.

2. Description of the Related Art

In general, when a digital device such as personal computer (PC) or notebook computer becomes outdated, a user often wishes to upgrade to a new computer. However, the user is generally apprehensive about losing vital machine information, such as personal data, customized settings, and/or any other essential configurations during data migration. During migration, if by any chance some of the previous machine information is lost, the user needs to spend additional effort and time to manually customize the new computer. As a result, the user tends to overlook the machine information during a new installation, and therefore the user experience is diminished and the user is discouraged from purchasing the new computer.

The conventional techniques require the user to first understand the details of the machine information (such as personal data, customized settings, or any other configurations) along with the location of such information on their existing computer. As a result, it becomes cumbersome, and impractical for the user to manually customize and restore the new computer. Therefore, the conventional techniques are unable to provide automated, fast, easy and user-friendly computer data migration.

Therefore, there exists a need to provide a method and apparatus for providing reliable and easy to use data migration services to purchasers of new computers.

### SUMMARY OF THE INVENTION

Embodiments of the present disclosure generally include a method for data migration. A computer implemented method for data migration comprises collecting a plurality of parameters from a user device, storing the plurality of parameters as migration data in a database, and imaging a new device with the migration data.

Embodiments of the present disclosure generally include an apparatus for data migration. The apparatus comprises a server for collecting a plurality of parameters from a user device, a database coupled to the server for storing the plurality of parameters as migration data, and an imaging module coupled to the database for imaging a new device with the migration data.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a functional block diagram of a system for migrating data in accordance with exemplary embodiments of the present invention;

FIG. 2 illustrates a flow diagram of a method for migrating data in accordance with exemplary embodiments of the present invention.

### DETAILED DESCRIPTION

As explained further below, various embodiments of the invention disclose a method and apparatus for providing data migration services for digital devices such as personal computing devices. The embodiments of the present invention download a software application (such as an applet) to the user's computer, collect personal settings, computer configurations and installed software as well as corporate and machine settings, and process an order to build a new device that incorporates all of the settings, configurations and software from the user's current computer. Hereinafter such digital information is sometimes collectively referred to as “parameters”. The manufacturer of the new device will then ship the new device to the user and the user will be able to start the device in a state equivalent to that of the user's former computer.

Further, the embodiments of the invention provide an end-to-end data migration service for a user purchasing a new computer. The user can comfortably access an online store, such as Sony Style®, to purchase a new personal computer or laptop (PC). If the user decides to purchase a new PC, the user is presented with an option to migrate their existing computer data to a new PC. If the user agrees, an Applet and/or ActiveX (or any suitable application) control is enabled for execution on the user's current computer that analyzes its parameters, i.e., all of the customized user settings and data such as Operating system customizations, bookmarks, licensed software, stored data and the like, stores such data in a database server and submits the order. A PC manufacturing service retrieves this data from a server coupled to the database and images the newly ordered PC with the migration data and ships it out to the customer. Once the customer starts the new PC, the transition from their outdated PC to the new PC will be seamless as all their data and settings have been successfully transferred. The user does not need to have the expertise to perform manual migration and may simply resume their normal usage patterns immediately with the new computer.

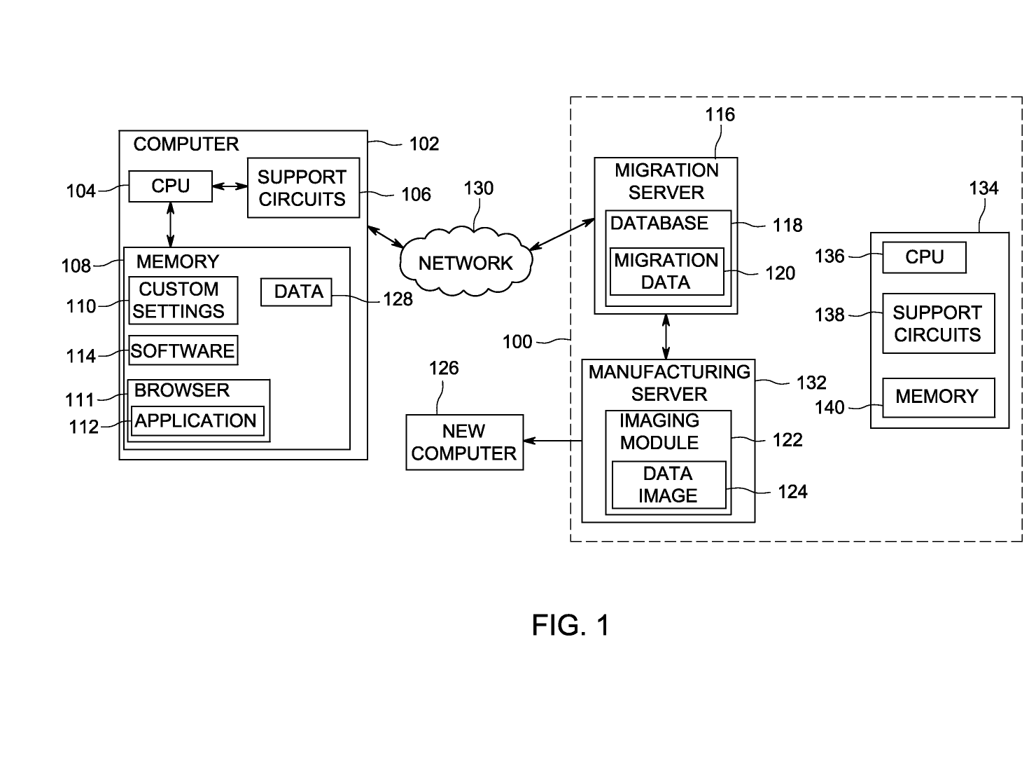

FIG. 1 depicts a functional block diagram of a system 100 for migrating data in accordance with exemplary embodiments of the present invention. The system 100 comprises a migration server 116, and a manufacturing server 132 operatively coupled to each other. A client computer 102 couples to the system 100 through a network 130. The system 100 further depicts a new computer 126 coupled with the imaging module 122.

The client computer 102 comprises a central processing unit (CPU) 104, support circuits 106, and memory 108. The computer 102 is a type of computing device (e.g., a laptop, a desktop, a notebook, a gaming device, a handheld device, other electronic device and/or the like) known to one of ordinary skill in the art. The CPU 104 may comprise one or more commercially available microprocessors or microcontrollers that facilitate data processing and storage. The various support circuits 106 facilitate the operation of the CPU 104 and include one or more clock circuits, power supplies, cache, input/output circuits, displays, and the like. The memory 108 comprises at least one of Read Only Memory (ROM), Random Access Memory (RAM), disk drive storage, optical storage, removable storage and/or the like, but excludes transitory media. The memory 108 comprises custom settings 110, data 128, software 114, and a browser 111 including an application 112.

The network 130 comprises a communication system that connects computers by wire, cable, fiber optic and/or wireless link facilitated by various types of well-known network elements, such as hubs, switches, routers, access points and the like. The network 130 may employ various well-known protocols to communicate information amongst the network resources. For example, the network 130 may be a part of the Internet or Intranet using various communications infrastructure, such as Ethernet, Wi-Fi, Wi-Max, General Packet Radio Service (GPRS), and the like.

The migration server 116 is a type of computing device (e.g., a desktop, and/or the like) known to one of ordinary skill in the art. The migration server 116 comprises a database 118. The database 118 records migration data 120 of the client computer 102. According to some embodiments, the migration server 116 may further comprise a web server and an application server, or any other server that may utilize the data migration and restoration services from an online seller of new computers, such as the forenamed Sony Style®, store. In other embodiments, the database 118 is hosted remotely from the server 116.

The manufacturer server 132 is a type of computing device (e.g., a desktop, and/or the like) known to one of ordinary skill in the art. The manufacturer server 132 comprises an imaging module 122. The imaging module 122 produces and stores a data image 124.

According to some embodiments of the present invention, the client initially powers the computer 102 and launches the browser 111. The client navigates to a particular website, in this embodiment the Sony Style® site, through the network 130. The server 116 transmits an application, i.e. the application 112 to the browser 111 of the computer 102. The browser 111 executes the application 112 as an Applet, ActiveX control or the like on client computer 102. The application 112 allows the migration server 116 to access in-depth details of the client computer 102 such as applications, control settings, software configurations, browser bookmarks and the like. In other embodiments, the application 112 is downloaded to the client computer 102 and is executed by the CPU 104 at a time scheduled by a user of the computer 102. The results are transmitted to the migration server 116 at a later time.

Application 112 is required because conventionally a website is unable to access such in-depth information due to browser 111 security restrictions, firewalls and computer 102 security policies in place to protect the user and client computer 102. However, Applets, ActiveX controls and other controls used for accessing and then extracting in-depth machine information, prompt the user to grant security permission for such access and extraction. The user selects a new PC with desired configuration details such as processor speed, random access memory (RAM) size, hard disk size and the like through the website running in browser 111. The user submits the new PC configuration as an order to the migration server 116 and then the application 112 prompts the user for security permission and whether the user would like to perform end-to-end PC migration services. In general, the applets can be executed by browsers for many platforms, including Microsoft Windows, Unix, Mac OS and Linux.

According to some embodiments, the application 112 enables the migration server 116 to collect the user customizations/settings, i.e. the custom settings 110, the software 114 and the data 128. The custom settings 110 may include various parameters of the computer 102, such as user settings, customizations, contents, user preferences, network settings, browser settings and favorites and the like. Further, the application 112 may also store the combined settings (retrieved by the applet) and user choices (made by the user during the interaction with the applet) to a local storage device.

Further, the application 112 collects the user data, i.e. the data 128 residing on the computer 102. The data 128 may include the basic file system of the computer 102 and all data populating the file system to be migrated to the new computer. According to some embodiments, the data 128 may include MS word files, Adobe PDF files, media (audio/video) files, and/or the like. According to some embodiments, the server 116 stores the custom settings 110 and the data 128 as migration data 120 in the database 118. In some embodiments, the migration data 120 is encrypted and sent to the manufacturer server 132, where the manufacturer then builds and configures a new computer in accordance with the received migration data 120.

According to some embodiments, the manufacturer server 132 decrypts the encrypted migration data 120 received from the database 118. The imaging module 122 retrieves the migration data 120 from the migration server 116 and processes the data 120 to generate a data image 124. The data image 124 is a binary file which contains the entirety of the data captured from client computer 102 including software, data, custom settings, licenses, application defaults and the like. The binary file format of the data image 124 is such that the underlying representation of the data can be copied to a new hard disk or memory and the data in the data image 124 will cause the software and settings to be copied directly to the hard disk of the new computer 126. According to some embodiments, the imaging module 122 applies the data image 124 to the new computer 126. The new computer 126 is delivered to the user and the user is able to operate the new computer 126 in fully configured and activated mode directly out of the manufacturers shipping container.

One of ordinary skill in the art would recognize that migration server 116 and manufacturing server 132, in one embodiment, comprise individual central processing units, supporting circuits and memories (not shown). The migration data 120 is stored in database 118, which, according to an exemplary embodiment is executed by the central processing unit of the migration server 116. In other embodiments, the database 118 is stored remotely from the migration server 116. The imaging module 122 is stored in the memory of the manufacturing server 132 and executed by the central processing unit of the manufacturing server 132. The data image 124 is also stored on the memory of the manufacturing server 132. According to other embodiments, the migration server 116 and the manufacturing server 132 share a central processing unit 136, support circuits 138 and memory 140 as shown in FIG. 1 and are run as “cloud” computing services on a cloud server 134, whereby they are accessible as services.

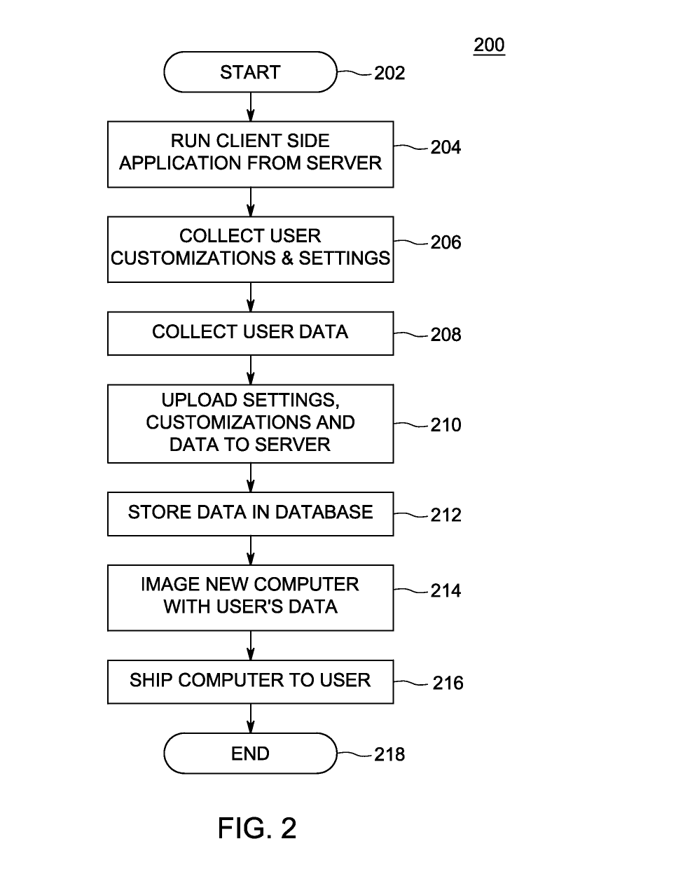

FIG. 2 is a flow diagram of a method 200 for migrating data in accordance with exemplary embodiments of the present invention. The method 200 is an implementation of the migration server 116 and the manufacturing server 132 of FIG. 1.

The method 200 begins at step 202 and proceeds to step 204. At step 204, a client side application is transmitted from the migration server 116 and run on the browser 111 of the client computer 102. At step 206, user customizations and settings are collected by the client side application. According to some embodiments, the application 112 enables the server 116 to collect the user customizations/settings, i.e. the custom settings 110 and the data 128.

In some embodiments, the custom settings 110 may include various parameters of the computer 102, such as customizations, network settings, software licenses and the like. Before collecting this data, the application 112 prompts for permission from the user and the browser 111 warns of possible security risks in allowing the application 112 to access computer data.

At step 208, user data is collected. According to some embodiments, the server 116 collects the user data, i.e. the data 128 residing on the computer 102. According to some embodiments, the data 128 may include MS word files, Adobe®, PDF files, media (audio/video) files, software settings and/or the like. The data 128 may further include the basic file system of the computer 102 and all data populating the file system to be migrated to the new computer.

At step 210, settings, customizations, and data are uploaded to the migration server 116. According to some embodiments, the migration server 116 parses the custom settings 110 and the data 128 and generates migration data 120. At step 212, the migration data 120 is stored in the database as a record. The migration data 120 is associated with an order submitted by the user of the client computer 102 and can be retrieved by customizable identifying information such as an order number, client computer address, or the like. According to some embodiments, the server 116 stores the custom settings 110 and the data 128 as migration data 120 in the database 118. In other embodiments, the database 118 is hosted remotely from the server 116.

At step 214, a new computer is imaged with the migration data 120. According to some embodiments, the imaging module 122 images the migration data 120 as a data image 124 and applies the data image 124 to a new computer, i.e. the new computer 126. The process of imaging a new computer is well known to those of ordinary skill in the art, and generally comprises reading each byte from the data image 124 and directly writing each byte to the hard disk of the new computer. In this manner, the new computer 126 contains a replication of custom settings, application defaults, and user content of the client computer 102 as stored in migration data 120 so that a user may continue computing without suffering any delay or inconvenience in manually configuring or transferring data to the computer 126. At step 316, the new computer 126 is shipped to a user. The method 300 ends at step 218.

The embodiments of the present invention offer various advantages. The embodiments provide an end-to-end service that enables a simple customer migration from one computer to a second computer in a very short time. The user may browse a website or electronics storefront to initiate and complete the purchase and migration process. Further the migration process can be initiated even from a home without having to understand the details of the system information, such content, settings, user preferences, etc. Finally, when the new computer arrives, the user can cause it to awake from hibernation and all of the user data and settings are preconfigured so the user suffers no interruption in usage.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

While the foregoing is directed to embodiments of the present invention, other and further embodiments of the invention may be devised without departing from the basic scope thereof, and the scope thereof is determined by the claims that follow.

1. A computer-implemented method for data migration comprising:
collecting a plurality of parameters from a user device;
storing the plurality of parameters as migration data in a database; and
imaging a new device with the migration data.

2. The method of claim 1, wherein the plurality of parameters comprises one or more of user settings, customizations, contents, user device, and network settings.

3. The method of claim 2, wherein the devices being imaged are hard disk drives of computers.

4. The method of claim 1, wherein collecting the plurality of parameters comprises providing an application for execution on the user device to collect the plurality of parameters.

5. The method of claim 4, wherein executing an application comprises executing an applet program on a browser of the user device for retrieving the plurality of parameters.

6. The method of claim 1, wherein imaging the new device comprises forming a data image of the migration data.

7. The method of claim 1, wherein imaging the new device further comprises transferring and applying the data image to the new device.

8. An apparatus for data migration comprising:
a migration server for collecting a plurality of parameters from a user device;
a database coupled to the migration server for storing the plurality of parameters as migration data; and
an imaging module coupled to the database for imaging a new device with the migration data.

9. The apparatus of claim 8, wherein the plurality of parameters comprises at least one of user settings, customizations, contents, user preferences, and network settings.

10. The apparatus of claim 9, wherein the devices being imaged are computers.

11. The apparatus of claim 8, wherein the migration server provides an application for execution on the user device to collect the plurality of parameters.

12. The apparatus of claim 11, wherein the application is an applet program executed on a browser of the user device for retrieving the plurality of parameters.
